(19) United States
(12) Patent Application Publication
(10) Pub. No.: US 2008/0020482 A1
(43) Pub. Date: Jan. 24, 2008

(54) Assay Devices

(75) Inventor: Balbir Raj, Bedford (GB)

Correspondence Address: FOLEY HOAG, LLP;PATENT GROUP (w/ISA), 155 SEAPORT BLVD., BOSTON, MA, 02210-2600, US

(73) Assignee: Inverness Medical Switzerland Gmbh

(21) Appl. No.: 11/570,404

(22) PCT Filed: Jun. 8, 2005
(86) PCT No.: PCT/GB05/02266

§ 371 Date: May 23, 2007

(30) Foreign Application Priority Data
Jun. 10, 2004 (GB) 0412949.0

(51) Int. Cl. G01N 21/00; B21D 39/00; G01N 21/01

(52) U.S. Cl. 436/165; 29/428; 422/58

(57) ABSTRACT

An assay device may include a housing, at least partially within which is housed a test strip. The housing may define a test window through which a test zone of the test strip may be viewed. The device may include a movable portion which is movable between first (“testing”) and second (“reading”) positions such that, at the first position the movable portion covers the test window, thereby obscuring the test zone, and such that movement of the movable portion from the first position to the second position uncovers or reveals the test zone, rendering the test zone available for visual inspection. The movable portion may include a visual indicator which can be positioned, by movement of the movable portion, so as to be apparent in the test window to a user viewing the test result.

### FIELD OF THE INVENTION

The present invention provides an assay device for determining the presence or absence of an analyte of interest in a sample and a method of performing an assay.

### BACKGROUND OF THE INVENTION

The use of lateral flow assay devices for detecting the presence and/or amount of an analyte in a fluid sample has previously been proposed, as discussed in EP 291194. In such assay devices, a sample is applied to a region of a test strip and permeates along the strip. The sample initially flows through a reaction zone containing a labelled specific binding reagent that is freely mobile within the test strip when moist, and then into a test zone located downstream from the reaction zone. The test zone contains an immobilised specific binding reagent capable of binding either the labelled binding reagent or the analyte of interest. The test strip may also comprise a fluid sink to allow any unbound reagent or analyte to wash out of the test zone. A control zone may also be provided downstream of the test zone.

Vertical flow assay devices may also be used in detecting the presence of analyte in a sample, as disclosed in U.S. Pat. No. 4,632,901. In such assay devices, a liquid sample is introduced and allowed to pass through one or more layers to generate a result, which may be in the form of a visual signal.

The presence of analyte and hence associated labelled reagent bound to the immobilised reagent in the test zone can be observed using any of several methods to detect the label. Preferably, such assay devices produce a characteristic signal in the presence of analyte in a sample, and a different signal in the absence of analyte. More preferably, test devices have been developed and sold commercially in a format that displays a “plus” (+) sign in the presence of analyte, and a “minus” (−) sign in the absence of analyte.

Also of relevance to the present invention are the test devices described in U.S. Pat. No. 4,916,056, in which a visual indicator is formed by causing a labelled reagent to bind to an immobilised binding substance provided as a line that is parallel to the direction of sample flow. Regardless of whether the analyte of interest is present in the sample, the labelled binding reagent will bind to the immobilised binding substance of the visual indicator. However, in the presence of analyte, the labelled specific binding reagent binds to the analyte, forming a reagent/analyte complex, which complex is captured by a further immobilised binding reagent deposited in a “test line” that is positioned transversely across the membrane and is perpendicular to the direction of sample flow. The test line may be viewed in combination with the visual indicator, such that a “plus” sign is provided as a consequence of a labelled binding reagent-analyte complex formed at the test zone.

A similar approach is described in EP 0260965, which discloses a multiple-step diagnostic assay with a visual indicator sprayed onto a test membrane.

A further example of an assay device is disclosed in WO 2004/011942 A1. WO 2004/011942 A1 discloses an assay device wherein a test strip is positioned in a housing which is shaped and configured to allow the detection of the test strip from the side, in contrast with other devices wherein detection is from the lengthwise axis of the test strip. The housing is generally C-shaped and the test strip spans the two arms of the C-shape. The test strip is preferably embedded with paramagnetic particles and quantitative analysis may be achieved using a magnetic reader device. In addition, the housing is sealed by means of a removable cover which protects the test strip during storage and transport.

Another method for providing a “plus” sign includes the provision of a pH sensitive dye on the test strip, as disclosed in U.S. Pat. No. 5,660,790.

In most of the prior art methods discussed above, a “minus” sign is visualised in the absence of analyte by placing an indicator line, perpendicular to the test line, directly onto the test strip. The “minus” sign is “converted” into a “plus” sign in the presence of analyte in the sample. The “minus” sign may be provided by the deposition of a labelled reagent or by a preformed printed line.

Although such assay techniques are well known in the art, they have not been without drawbacks. For example, one of the disadvantages associated with such techniques is the requirement of a manufacturing step to apply the indicator line to the test strip. The methods discussed above generally require the addition of further biochemical reagents to the test strip and/or require manipulation of the delicate test strip membrane. This may have the effect of increasing the cost of producing such test strips, may lead to problems of incompatibility, and may compromise the stability of the biochemical reagents on the test strip. Furthermore, in some cases, the signal generated by the assay is not clear.

Another, approach for providing a visual indicator on a test strip is described in US 2003/0157699, wherein the test device is comprised of a matrix, the matrix comprising a first porous member which comprises a reaction zone and a test zone, and a second member positioned below, and in contact with the first member. The first member is comprised of a material which is opaque when in a dry state and transparent when in a moist state. A visual indicator is placed on the second member, positioned perpendicular to the test line, and represents a “minus” sign which becomes visible through the test zone in the first member when the first member is in the moist state. The visual indicator can be observed once the matrix is wet, whereas a “plus” sign is apparent only in the presence of analyte.

The above technique has the advantage that the visual indicator is provided on the second member, such that there is no requirement for the addition of further reagents to the delicate test strip membrane. However, one of the problems associated with this technique is that the visual indicator may be visible through the test strip membrane, even when in the dry state.

Therefore, it would be advantageous to provide a test strip that does not require the extra processing step of depositing a line or other visual indicator onto the test strip, and preferably does not provide a visual indicator that can be seen before the sample has been added to the device.

### SUMMARY OF THE INVENTION

The present invention provides an assay device for determining the presence or absence of an analyte of interest in a sample, the device comprising a housing, at least partially within which is housed a test strip; wherein the housing comprises a test window through which a test zone of the test strip may be viewed; the device further comprising a movable portion which is movable between first (“testing”) and second (“reading”) positions; wherein, at the first position the movable portion covers the test window, thereby obscuring the test zone; and wherein movement of the movable portion from the first position to the second position uncovers or reveals the test zone, rendering the test zone available for visual inspection.

In a second aspect, the present invention provides an assay device for determining the presence or absence of an analyte of interest in a sample, the device comprising a housing, at least partially within which is housed a test strip; wherein the housing comprises a test window through which a test zone of the test strip may be viewed; the device further comprising a movable portion which is movable between first (“testing”) and second (“reading”) positions; and wherein the movable portion comprises a visual indicator which can be positioned, by movement of the movable portion, so as to be apparent in the test window to a user viewing the test result.

In another aspect, the present invention provides a method of determining the presence or absence of an analyte of interest in a sample, the method comprising the step of: contacting the sample with an assay device, the device comprising a housing, at least partially within which is housed a test strip; wherein the housing comprises a test window through which a test zone of the test strip may be viewed; the device further comprising a movable portion which is movable between first (“testing”) and second (“reading”) positions; wherein, at the first position the movable portion covers the test window, thereby obscuring the test zone; and wherein movement of the movable portion from the first position to the second position uncovers or reveals the test zone, rendering the test zone available for visual inspection.

In a further aspect, the present invention provides a method for determining the presence or absence of an analyte of interest in a sample, the method comprising the step of: contacting the sample with an assay device, the device comprising a housing, at least partially within which is housed a test strip; wherein the housing comprises a test window through which a test zone of the test strip may be viewed; the device further comprising a movable portion which is movable between first and second positions; and wherein the movable portion comprises a visual indicator which can be positioned, by movement of the movable portion, so as to be apparent in the test window to a user viewing the test result.

Conveniently, a method in accordance with the present invention comprises use of an assay device in accordance with the first and second aspects of the invention.

In a further aspect, the present invention provides a method of making an assay device in accordance with the first and/or second aspect of the invention defined above.

Conveniently the movable portion of the device may form part of the housing. In a preferred embodiment, the movable portion of the device is capable of being moved by sliding, but other types of movement are possible, such as rotation (about a horizontal or a vertical axis), simultaneous lifting (or depressing) and translation, and so on. Preferably, the movable portion of the housing remains attached to, or secured within, the housing during movement of the portion. More preferably, the movable portion remains attached to, or secured within, the housing during movement of the movable portion relative to the housing.

In a device in accordance with the first aspect of the present invention, the movable portion of the housing preferably comprises a transparent or translucent region and an opaque region, such that when the movable portion of the housing is in the first position, the opaque region covers the test window, thereby obscuring the test zone; and when the movable portion of the housing is moved to the second position, the transparent or translucent region is positioned over the test window, thereby revealing the test zone.

In a device in accordance with the second aspect of the invention, the movable portion of the device preferably comprises a transparent or translucent region, on which is provided a visual indicator. Preferably, the visual indicator is a line positioned along the long axis of the test strip membrane and substantially parallel to the direction of flow of the sample along the test strip. Typically, the visual indicator is a coloured line. More specifically, the visual indicator preferably has the appearance of a minus sign. Thus movement of the movable portion to the second position can place a visual indicator, such as a minus sign, within or over the test window, where it will be apparent to a person inspecting the device.

According to the first aspect of the invention, during the assay the movable portion of the device is in the first position, such that the opaque region covers the test window. When the assay is complete, movement of the movable portion from the first position to the second position uncovers the test window and hence reveals the test zone.

According to the second aspect of the invention, the movable portion of the housing is moved from the first position to the second position when the assay is complete, such that the visual indicator provided on the transparent or translucent region is apparent in the test window to a user viewing the test result.

Preferably an assay device will be in accordance with both the first and second aspects of the invention, such that movement of the movable portion from the first position to the second position will (i) reveal the test zone and (ii) position a visual indicator, such as a minus sign, within or over the test window.

The assay device of the present invention is preferably a lateral flow immunoassay device.

In preferred embodiments of the present invention, the test strip is in liquid flow communication with a sample receiving zone (situated out with the housing) to which the sample is applied. The test strip generally comprises a reaction zone containing a labelled specific binding reagent that is capable of binding the analyte of interest to form a labelled reagent-analyte complex, and a test zone containing an immobilised reagent capable of binding the labelled reagent-analyte complex.

Typically, the reaction zone is located downstream from the sample receiving zone and the test zone is located downstream from the reaction zone.

Advantageously, the test strip carrier membrane is porous, allowing the sample applied to the sample receiving zone to permeate along the test strip. Preferably, nitrocellulose is selected as the test strip material. This has advantages over conventional test strip materials, such as paper, as it has a natural ability to bind proteins without the requirement for prior sensitisation.

In a preferred embodiment, the binding of the labelled reagent-analyte complex to the immobilised reagent in the test zone results in the production of a test line that can be observed through the test window of the assay device. In the absence of analyte, only the visual indicator in the test window is observed; whereas, in the presence of analyte, the presence of the test line in the result window can be viewed in combination with the visual indicator provided on the transparent or translucent region of the movable portion of the device. Conveniently, the visual combination of the test line and the visual indicator provides some additional information or meaning to a user. For example, in preferred embodiments a “minus” sign (provided by the visual indicator) is observed in the absence of analyte and a “plus” sign (formed by the visual combination of visual indicator and test line) is observed in the presence of analyte.

In a preferred embodiment, the colour of the visual indicator provided on the transparent or translucent region of the housing is identical or closely similar to the colour of the labelled reagent bound to the analyte, and hence is identical or closely similar to the colour of the test line, thus enhancing the visual impression of combination between the test line and the visual indicator.

In another preferred embodiment of the invention, a coloured portion that is similar to the colour of the visual indicator may be provided on the housing, such that when the movable portion of the device is in the first position, obscuring the test window, the visual indicator may not be readily perceived by a user, since it will “blend in” with the identically or closely similar coloured portion of the housing.

Assay devices in accordance with the invention will preferably comprise a control zone. Preferably, the control zone is visible to the user during the assay through a control window formed in the housing and provides a signal to indicate that the assay is complete and that the assay has been performed correctly. Typically, the control signal provided may be the appearance or absence of colour in the control zone.

In one embodiment of the invention, when the movable portion of the housing is in the first position and an opaque region is obscuring the test window, the absence of a control signal in the control zone indicates that the test is incomplete. The appearance of a control signal in the control zone provides an indication to a user that the test is complete. The user can then move the movable portion of the housing into the second position such that the transparent or translucent region is situated over the test window, thus revealing the test result.

Typically, the control window is located downstream of the test window and may conveniently be of different shape to the test window, such that the control signal and test signal are readily distinguished.

Test devices in accordance with the first aspect of the present invention possess the advantage that only the control zone is visible to a user during the assay. This allows the user to concentrate their attention on the control zone. In addition, since the test window is obscured, the user is less likely to make a premature reading and instead must wait until a signal appears in the control zone, indicating that the test is complete. The movable portion of the device can then be moved to reveal the test result.

Test devices in accordance with the second aspect of the invention described herein enable a visual indicator to be placed in a precisely controlled location within the transparent or translucent region on the movable portion of the device which can be observed when the transparent or translucent region is positioned above the test window, thus avoiding the appearance of an indicator line in the test window before the sample has been added to the device.

The present invention avoids the requirement for further biochemical or chemical processing of the membrane to produce a control line. As the invention does not require the deposition of a labelled reagent or a pre-formed printed line on the test strip membrane, the cost of manufacturing the device would be reduced.

The invention will now be further described by way of illustrative example and with reference to the accompanying drawings, in which

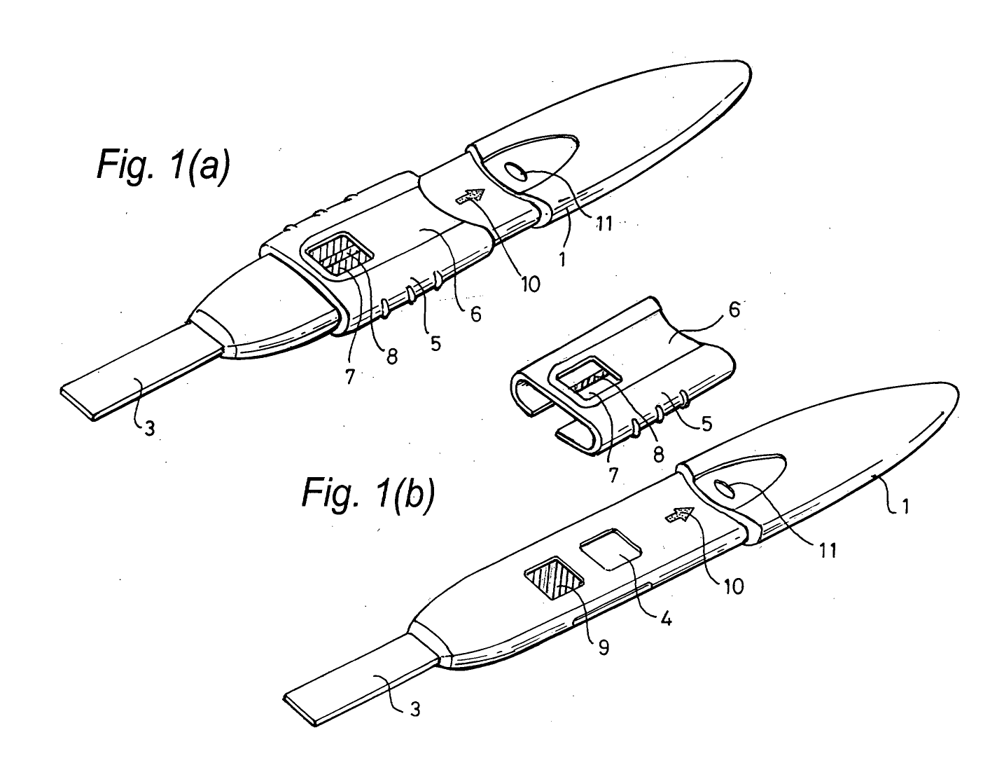

FIG. 1(a) is a perspective view of a test device in accordance with the invention;

FIG. 1(b) is a partially exploded perspective view of the embodiment illustrated in FIG. 1(a);

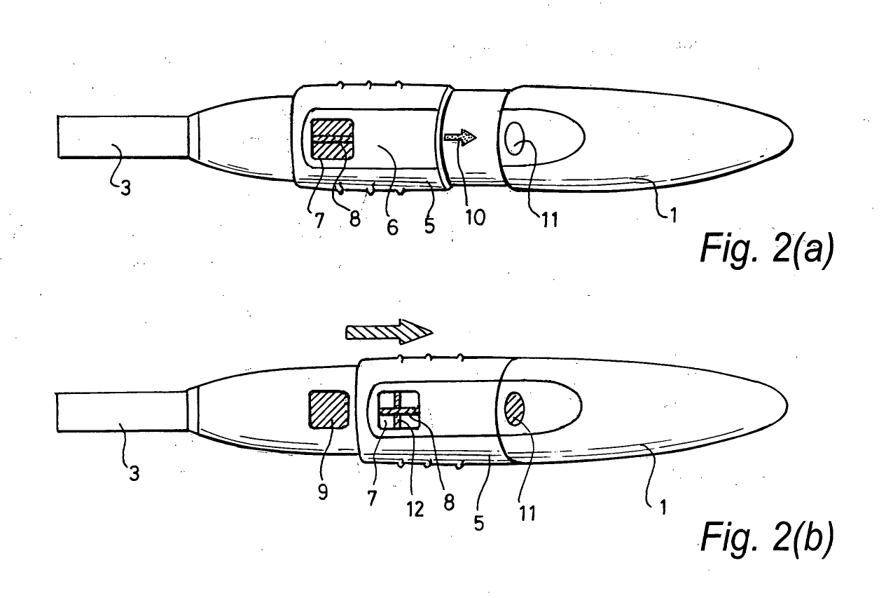

and FIGS. 2(a) and (b) are plan views of the embodiment of the test device illustrated in FIG. 1, wherein a movable portion of the device housing is shown in first and second positions respectively.

### DETAILED DESCRIPTION OF THE INVENTION

The present invention provides an assay device for determining the presence or absence of an analyte of interest in a fluid sample. A preferred embodiment of the present invention can be seen in FIG. 1 which shows an assay device in accordance with the first and second aspects of the invention. FIG. 1(a) shows a perspective view of the assay device, wherein a movable portion is attached to the housing and is in a first position. FIG. 1(b) shows a partially exploded perspective view of the assay device, wherein the movable portion is detached from the housing.

The assay device comprises a housing (1) within which is housed a test strip. The test strip is in liquid flow communication with a sample receiving zone (3) to which the sample is applied. The test strip comprises a reaction zone containing a freely mobile labelled specific binding reagent capable of binding the analyte of interest and forming a labelled regent-analyte complex, and a test zone containing an immobilised reagent capable of binding the labelled reagent-analyte complex. The test zone is observed through a test window (4) (see FIG. 1(b)) that is provided in the housing (1).

An integral part of the housing (1) is a movable portion (5) comprising an opaque region (6) and a transparent or translucent region (7), on which is provided a visual indicator (8). The visual indicator is provided as a coloured line (having the appearance of a “minus” sign), the colour of which corresponds to the colour of the labelled reagent bound to the analyte in the test zone, thus enhancing the visual impression of the combination of the test line and the visual indicator. A coloured portion (9) is provided on the housing (1), and is identical or closely similar to the colour of the visual indicator (8) present on the transparent or translucent region (7) such that when the movable portion of the housing (5) is in the first position and is obscuring the test window (4), the visual indicator (8) may not be readily perceived by a user, as it will “blend in” with the identical or closely similar coloured portion (9) of the housing (1).

The movable portion of the device (5) is movable between first and second positions (as best seen in FIGS. 2(a) and (b)). In the first position, the movable portion (5) covers the test window (4), thereby obscuring the test zone. The transparent or translucent region (7) is positioned over the coloured portion of the housing (9) such that the user is unable to perceive the visual indicator (8). Movement of the movable portion from the first position to the second position uncovers the test window such that the visual indicator (8) becomes apparent in the test window (4) to a user viewing the test result. The movable portion of the housing (5) is moved by sliding in the direction of the arrow (10).

A control zone (11) is provided on the housing (1), downstream of the test window (4). The control zone (11) is visible to the user during the assay by virtue of a suitably positioned control window formed in the housing and provides a signal to indicate that the assay is complete, and that the assay has been properly performed. During the assay, when the movable portion of the housing (5) is in the first position, the absence of colour in the control zone (11) indicates that the test is incomplete. In this case, the movable portion of the housing (5) obscures the test window (4) and the attention of the user is concentrated on the control zone (11). The appearance of colour in the control zone (11) indicates that the test is complete and the movable portion of the housing (5) can be moved to the second position, such that the transparent or translucent region (7) is positioned above the test window (4) to reveal the test result.

FIGS. 2(a) and (b) provide an illustration of the assay device of the present invention during the assay and after the assay, respectively. The assay device shown in FIG. 2 operates in the same way as that discussed in FIG. 1 above, with the individual components of the device numbered correspondingly.

During the assay, when the movable portion of the housing (5) is in the first position, the visual indicator (8) is located above the coloured portion of the housing (9) and cannot be perceived by a user. In the presence of analyte, a test line (12) is produced in the test zone as a consequence of the labelled reagent-analyte complex binding to the immobilised reagent in the test zone. Preferably, the test line (12) is positioned transversely across the test strip and is perpendicular to the direction of sample flow. The test line (12) can be viewed through the test window (4).

After the assay, when the movable portion of the housing (5) is moved to the second position, the presence of the test line (12) can be viewed in combination with the visual indicator (8). Therefore, a “plus” sign is observed in the presence of analyte (as shown in FIG. 2(b)) and a “minus” sign is observed in the absence of analyte.

1. An assay device for determining the presence or absence of an analyte of interest in a sample, the device comprising a test strip, the test strip having a reading zone wherein the result of the test may be observed; the device further comprising a movable portion which is movable from a first (“testing”) position to a second (“reading”) position; wherein, at the first position the movable portion obscures the reading zone, and wherein movement of the movable portion from the first position to the second position uncovers or reveals the reading zone, rendering the reading zone available for visual inspection.

2. An assay device for determining the presence or absence of an analyte of interest in a sample, the device comprising a test strip having a reading zone wherein the result of the test may be observed; the device further comprising a movable portion which is movable from a position remote from the reading zone into the reading zone; and wherein the movable portion comprises a visual indicator which can be positioned, by movement of the movable portion, so as to be apparent in the reading zone to a user viewing the test result.

3. An assay device in accordance with claim 1, wherein the movable portion comprises a visual indicator which can be positioned, by movement of the movable portion so as to be apparent in the reading zone to a user viewing the test result.

4. An assay device in accordance with claim 1, further comprising a housing, the test strip being at least partially housed within the housing.

5. An assay device according to claim 4, wherein the movable portion forms part of, or is attached to, the housing.

6. An assay device in accordance with claim 5, wherein the movable portion forms part of, or is attached to, the housing during movement of the movable portion relative to the housing.

7. An assay device in accordance with claim 1, wherein the movable portion comprises a transparent or translucent region and an opaque region.

8. An assay device in accordance with claim 7, such that when the movable portion is in a first position, the opaque region covers the reading window and/or obscures the reading zone; and when the movable portion is in a second position, the transparent or translucent region is positioned over the reading window and/or reveals the reading zone.

9. An assay device in accordance with claim 1, wherein the movable portion comprises a transparent or translucent portion, on which is provided a visual indicator.

10. An assay device in accordance with claim 1, comprising a visual indicator has the appearance of a minus sign, the long axis of which is substantially parallel to the direction of flow of the sample along the test strip.

11. An assay device in accordance with claim 1, wherein a visual indicator is provided on the movable portion, the visual indicator having a colour which is identical or closely similar to the colour of a labelled reagent accumulated in the reading zone as a test result line, thus enhancing the visual impression of combination between the test result line and the visual indicator.

12. An assay device in accordance with claim 1, wherein a visual indicator is provided on the movable portion, the visual indicator being obscured from view or not readily perceived when the movable portion of the device is in a first position.

13. An assay device in accordance with claim 12, wherein the visual indicator has a colour which is identical or closely similar to a coloured portion provided on the housing or test strip in the area generally around the visual indicator when the movable portion is in a first position, such that the visual indicator is not readily perceived, the test strip having a contrasting colour in the reading zone so that the visual indicator can be readily perceived when the movable portion is in a second position.

14. A method of determining the presence or absence of an analyte of interest in a sample, the method comprising the step of contacting the sample with an assay device in accordance with claim 1.

15. A method of making an assay device, the method comprising the step of assembling components so as to form an assay device in accordance with any one of claim 1.

16. (canceled)

17. A device comprising:
a housing;
a test strip at partially housed within the housing, the test strip having a reading zone wherein the result of the test may be observed;
a movable portion forming part of, or being attached to, the housing, the movable portion being movable from a first (“testing”) position to a second (“reading”) position; wherein:
at the first position the movable portion obscures the reading zone;
movement of the movable portion from the first position to the second position uncovers or reveals the reading zone, rendering the reading zone available for visual inspection; and
the movable portion comprises a visual indicator which can be positioned, by movement of the movable portion, so as to be apparent in the reading zone to a user viewing the test result.
